(19) United States
(12) Patent Application Publication
(10) Pub. No.: US 2019/0139408 A1
(43) Pub. Date: May 9, 2019

(54) DEVICE, SERVER, AND METHOD FOR DETERMINING A CASE OF WRONG-WAY DRIVING AND FOR PROVIDING A WARNING ABOUT THE WRONG-WAY DRIVING

(71) Applicant: Robert Bosch GmbH, Stuttgart (DE)

(72) Inventors: Christian Lellmann, Stuttgart (DE); Thomas Schindler, Berlin (DE)

(21) Appl. No.: 16/180,826

(22) Filed: Nov. 5, 2018

(30) Foreign Application Priority Data
Nov. 8, 2017 (DE) 102017219883.4

(51) Int. Cl. G08G 1/0967; G08G 1/056

(52) U.S. Cl. CPC G08G 1/096791; G08G 1/056

(57) ABSTRACT

A device for detecting a change in movement of a vehicle and for transmitting movement data values, includes a sensor unit, a localization unit, an evaluating unit, and a transmitting and/or receiving unit. A server for receiving movement data values and providing a warning about a case of wrong-way driving includes a transmitting and/or receiving unit and a processing unit. A method for determining whether a vehicle is traveling in the wrong direction includes determining a traffic route on which the vehicle is located, gathering movement data values that represent at least one measure for a change in movement of the vehicle, transmitting the movement data values to the server, and receiving from the server the warning about the vehicle traveling in the wrong direction.

### CROSS-REFERENCE TO RELATED APPLICATIONS

The present application claims priority under 35 U.S.C. § 119 to DE 10 2017 219 883.4, filed in the Federal Republic of Germany on Nov. 8, 2017, the content of which is hereby incorporated by reference herein in its entirety.

### FIELD OF THE INVENTION

The present invention relates to a device for detecting a change in movement of a vehicle and for transmitting movement data values, a server for receiving movement data values and providing a warning about a case of wrong-way driving, and a method for determining whether a vehicle is traveling in the wrong direction.

### SUMMARY

According to an example embodiment of the present invention, a device for detecting a change in movement of a vehicle and for transmitting movement data values includes a sensor unit for detecting the movement data values, the movement data values representing at least one measure for the change in movement, and a localization unit for determining a traffic route on which the vehicle is located. The device furthermore includes an evaluation unit for determining whether the measure for the change in movement deviates from a predefinable or predefined behavior, the behavior being predefinable or predefined depending on the traffic route, and a transmitting and/or receiving unit for transmitting the movement data values to a server when the measure for the change in movement deviates from the predefinable or predefined behavior according to predefined criteria.

A change in movement is understood to be, for example, a change in a speed of the vehicle and/or a change in a movement direction of the vehicle. A traffic route is understood to be, for example, a road (expressway, country road, etc.).

A predefinable or predefined behavior, the behavior being predefinable or predefined depending on the traffic route, is, for example, a movement of the vehicle along a travel direction of the traffic route, and/or a steering motion which corresponds to the curvature of the traffic route. Correspondingly, a measure for a change in movement of the vehicle deviates from the predefinable or predefined behavior when a change in the speed takes place, which results in a speed that is too high—as a function of a maximum speed depending on the traffic route (in Germany, for example, a maximum of 100 km/h on a country road)—or too low—as a function of a minimum speed depending on the traffic route (in Germany, for example, at least 60 km/h on an expressway when the present traffic situation permits this speed). In one further example embodiment, a measure for a change in movement of the vehicle deviates from the predefinable or predefined behavior when the vehicle changes its direction in such a way that the change goes beyond a necessary change in direction due to the traffic route (curve, etc.). This results, for example, in a departure from the traffic route and/or in travel opposite to a predefined travel direction. All these deviations alone and/or in appropriate combinations are an indication that the change in movement of the vehicle results in wrong-way driving of the vehicle and, therefore, poses a risk to the vehicle and to the occupants of the vehicle and/or further road users.

The device advantageously achieves enhancement of the safety of the vehicle and/or the safety of the further road users (further vehicles, pedestrians, bicyclists, etc.) which are affected by the change in movement—the extent of which deviates from a predefinable or predefined behavior—by way of these movement data values being gathered and transmitted to a server, where these movement data values are, for example, appropriately evaluated and/or processed and/or forwarded.

Preferably, the transmitting and/or receiving unit is/are designed for receiving, from the server, a warning about the vehicle traveling in the wrong direction.

Herein lies an advantage, for example, that a driver and/or one further occupant of the vehicle are/is warned about the wrong-way driving, the wrong-way driving otherwise possibly going unnoticed, for example. As a result, the wrong-way driving can be prevented and/or aborted, whereby the safety of the vehicle and/or the safety of the further road users is enhanced.

Preferably, the device includes an output unit for visually and/or acoustically and/or haptically outputting the warning about the wrong-way driving. This advantageously allows for a simple and direct output which enables the wrong-way driving to be prevented and/or aborted as quickly as possible.

Preferably, the device is designed as a mobile device, in particular as a smartphone. Herein lies an advantage that the device can be utilized independently of a certain vehicle and, therefore, can be utilized by any driver and/or occupant of a vehicle. Moreover, this variant of the device is a cost-effective alternative, since the device does not need to be specifically installed into the vehicle.

The server according to an example embodiment of the present invention for receiving movement data values and providing a warning about a case of wrong-way driving includes a transmitting and/or receiving unit for receiving movement data values from a vehicle, the movement data values representing at least one measure for a change in movement of the vehicle, and providing a warning when the vehicle is traveling in the wrong direction. The server further includes a processing unit for determining whether, depending on the movement data values, the vehicle is traveling in the wrong direction.

The server according to the present invention advantageously evaluates the movement data to determine whether a case of wrong-way driving actually exists and, therefore, for example, carries out a plausibility check of the possible case of wrong-way driving. Certain computing capacities, which are generally available to a server, can be used therefor. Moreover, the safety is enhanced by way of the warning being provided when there is a case of wrong-way driving.

The movement data values preferably additionally represent a traffic route on which the vehicle is located and the determination whether the vehicle is traveling in the wrong direction takes place depending on the traffic route. This advantageously allows for a better and more precise assessment as to whether there is a case of wrong-way driving, or not.

Preferably, when there is a case of wrong-way driving, the warning is provided in such a way that the warning is transmitted to the vehicle and/or to at least one further vehicle.

Herein lies an advantage that the warning is broadcast in the best way possible and is provided to the vehicle and/or at least one further vehicle and/or further road users (further vehicles, pedestrians, bicyclists, etc.).

According to an example embodiment of the present invention, a method for determining whether a vehicle is traveling in the wrong direction includes a step of determining a traffic route on which the vehicle is located, and a step of gathering movement data values, the movement data values representing at least one measure for a change in movement of the vehicle. The method further includes a step of transmitting the movement data values to a server when the measure deviates from a predefinable or predefined behavior according to predefined criteria, the behavior being predefinable or predefined depending on the traffic route, the server being designed for determining, depending on the movement data values, whether the vehicle is traveling in the wrong direction and providing a warning about this wrong-way driving when the vehicle is traveling in the wrong direction. The method further includes a step of receiving, from the server, the warning about wrong-way driving of the vehicle when the vehicle is traveling in the wrong direction.

Advantageous refinements of the present invention are described in the description, and exemplary embodiments of the present invention are represented in the drawings and are explained in greater detail in the following descriptions.

### BRIEF DESCRIPTION OF THE DRAWING

FIGS. 1a and 1b illustrate a device according to an example embodiments of the present invention.

FIG. 2 illustrates a server according to an example embodiment of the present invention.

FIG. 3 is a flowchart that illustrates a method according to an example embodiment of the present invention.

### DETAILED DESCRIPTION

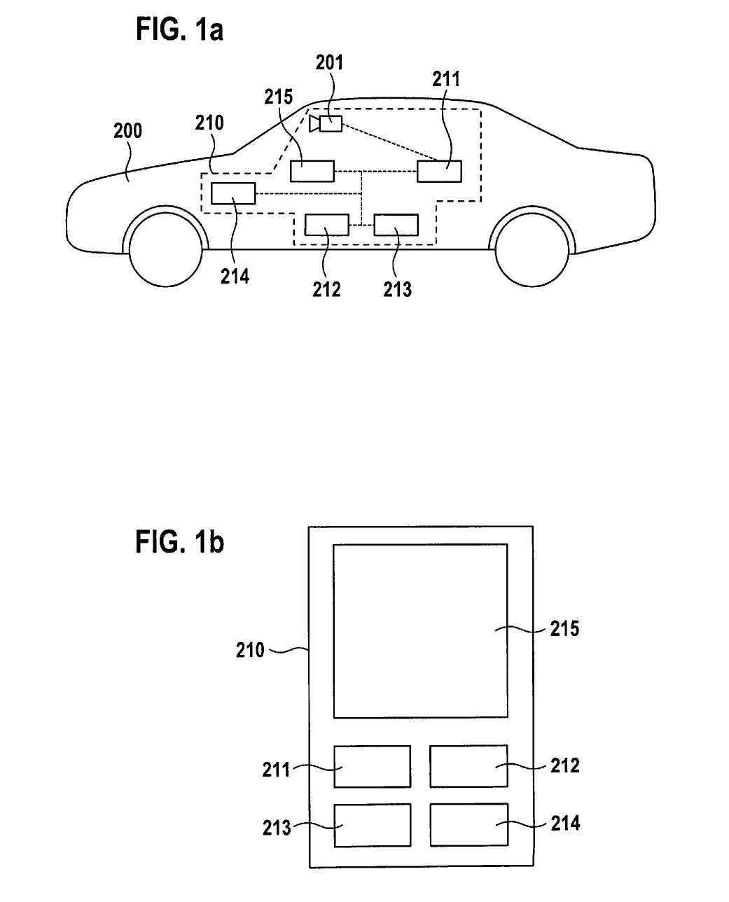

FIGS. 1a and 1b show two exemplary and different example embodiments of device 210 according to the present invention, device 210 being integrated in a vehicle 200 in the first example embodiment, FIG. 1a, and device 210 being designed as a mobile device, in particular as a smartphone, in the second example embodiment, FIG. 1b. In both example embodiments, the arrangements of the individual device elements as well as the proportions have been selected purely by way of example and are intended for illustration purposes.

FIG. 1a shows a vehicle 200 that includes device 210 for detecting a change in movement of vehicle 200 and for transmitting movement data values. Device 210 includes a sensor unit 211 for gathering 320 the movement data values, the movement data values representing at least one measure for the change in movement, and a localization unit 212 for determining 310 a traffic route on which vehicle 200 is located. Device 210 further includes an evaluation unit 213 for determining whether the measure for the change in movement deviates from a predefinable or predefined behavior, the behavior being predefinable or predefined depending on the traffic route, and a transmitting and/or receiving unit 214 for transmitting 330 the movement data values to a server 100 when the measure for the change in movement deviates from the predefinable or predefined behavior according to predefined criteria.

Sensor unit 211 for gathering 320 the movement data values includes, for this purpose, at least one sensor 201 which is designed for gathering the movement data values. The at least one sensor is designed as a video sensor, a radar sensor, a LIDAR sensor, an ultrasonic sensor, an acceleration sensor, a GPS sensor, a yaw rate sensor, a steering angle sensor, and/or a further sensor which is suitable for gathering a measure for a change in movement in the form of movement data values. In one further example embodiment, the at least one sensor 201 is not directly integrated in sensor unit 211. Instead, sensor unit 211 is designed in such a way that sensor unit 211 is connected to at least one sensor already integrated in vehicle 200. In one further example embodiment, sensor unit 211 additionally includes a processing unit (processor, working memory, hard drive) including software designed for gathering and/or processing the movement data values and/or making adaptations or changes to the data format. Moreover, sensor unit 211 is designed for forwarding the movement data values to evaluation unit 213.

If the at least one sensor 201 is designed, for example, as a video sensor, the measure for the change in movement is gathered, for example, by way of recorded images being appropriately evaluated (for example, by way of a detection of a rapid change in the surroundings gathered with the aid of sensor 201). If the at least one sensor 201 is designed, for example, as a steering angle sensor, the measure for the change in movement is gathered, for example, by way of a steering angle of a steering movement carried out by a driver of vehicle 200 being detected.

Localization unit 212 for determining 310 a traffic route on which vehicle 200 is located is designed, for example, as a navigation system. In this case, the traffic route is determined by way of a position of the vehicle being detected and compared with a map which includes the traffic route. In one further example embodiment, localization unit 212 is connected, for example, to sensor unit 211 in such a way that the traffic route is determined with the aid of a video sensor by way of traffic route-typical traffic signs (for example, in Germany, blue street signs indicate an expressway) being recognized. Moreover, localization unit 212 is designed for forwarding the determined traffic route, for example, in the form of data values, to evaluation unit 213.

Evaluation unit 213 for determining whether the measure for the change in movement deviates from a predefinable or predefined behavior, the behavior being predefinable or predefined depending on the traffic route, is designed, for example, as a processing unit (processor, working memory, hard drive) including suitable software for determining whether the measure for the change in movement deviates from a predefinable or predefined behavior.

In this case, the measure for the change in movement is compared, for example, with reference values stored on the hard drive, the appropriate reference value being utilized for the comparison depending on the traffic route.

Transmitting and/or receiving unit 214 for transmitting 330 the movement data values to a server 100 when the measure for the change in movement deviates from the predefinable or predefined behavior according to predefined criteria is designed for transmitting and/or receiving data via radio link. In one further example embodiment, transmitting and/or receiving unit 214 is designed in such a way that transmitting and/or receiving unit 214 is connected in a wired or wireless manner (for example, via Bluetooth) to transmitting and/or receiving means of vehicle 200 and is utilized as an interface between device 210 and the transmitting and/or receiving means of vehicle 200. In one further example embodiment, transmitting and/or receiving unit 214 is designed for receiving 340, from server 100, a warning about vehicle 200 traveling in the wrong direction.

In an example embodiment, device 210 additionally includes an output unit 215 for visually, acoustically, and/or haptically outputting the warning about the wrong-way driving. Depending on the embodiment, output unit 215 is designed, for example, as a display and/or a loudspeaker and/or a vibration unit.

FIG. 1b shows, by way of example, that device 210 for detecting a change in movement of vehicle 200 and for transmitting movement data values is designed as a mobile device, in particular, as a smartphone. Device 210 includes a sensor unit 211 for gathering 320 the movement data values, the movement data values representing at least one measure for the change in movement, and a localization unit 212 for determining 310 a traffic route on which vehicle 200 is located. Device 210 further includes an evaluation unit 213 for determining whether the measure for the change in movement deviates from a predefinable or predefined behavior, the behavior being predefinable or predefined depending on the traffic route, and a transmitting and/or receiving unit 214 for transmitting 330 the movement data values to a server 100 when the measure for the change in movement deviates from the predefinable or predefined behavior according to predefined criteria. Moreover, device 210 includes an output unit 215 for visually and/or acoustically and/or haptically outputting the warning about the wrong-way driving. The output unit is designed, for example, as a display and/or as a loudspeaker. In one further example embodiment, device 210 is additionally or alternatively designed for carrying out a haptic output of the warning via vibration. In this case, output unit 215 corresponds to a vibration mechanism.

Sensor unit 211 for gathering 320 the movement data values includes, for this purpose, at least one sensor 201 which is designed for gathering the movement data values. In this example embodiment, the at least one sensor is designed, for example, as an acceleration sensor, a GPS sensor, and/or a further sensor which is suitable for gathering a measure for a change in movement in the form of movement data values. In an embodiment, the change in movement is determined, for example, with the aid of a positioning function of the mobile device by way of detecting, via positioning, that there is a change in movement. In a further example embodiment, device 210 for gathering the movement data values includes an appropriately designed program, for example, an app.

Localization unit 212 for determining 310 a traffic route on which vehicle 200 is located is designed, for example, as a navigation system. In this case, the traffic route is determined by way of a position of the vehicle being detected and compared with a map which includes the traffic route. In a further example embodiment, device 210 for determining the traffic route includes an appropriately designed program, for example, an app.

Evaluation unit 213 for determining whether the measure for the change in movement deviates from a predefinable or predefined behavior, the behavior being predefinable or predefined depending on the traffic route, is designed, for example, as a processing unit (processor, working memory, hard drive) including suitable software for determining whether the measure for the change in movement deviates from a predefinable or predefined behavior. In an example embodiment, this suitable software is designed, for example, as an app.

The measure for the change in movement is compared, for example, with reference values stored on the hard drive and/or included in an app, the appropriate reference value being utilized for the comparison depending on the traffic route.

Transmitting and/or receiving unit 214 for transmitting 330 the movement data values to a server 100 when the measure for the change in movement deviates from the predefinable or predefined behavior according to predefined criteria is/are designed for transmitting and/or receiving data via radio link. In an example embodiment, transmitting and/or receiving unit 214 is/are designed for receiving 340, from server 100, a warning about vehicle 200 traveling in the wrong direction.

In an example embodiment, device 210 is designed as a mobile device in such a way that sensor unit 211, localization unit 212, evaluation unit 213, and/or transmitting and/or receiving unit 214 each includes a processing unit (processor, working memory, hard drive, including suitable software) and/or, at least partially, a shared processing unit (processor, working memory, hard drive, including suitable software). In a further example embodiment, in particular when device 210 is designed as a smartphone, the device includes a processing unit (processor, working memory, hard drive) which is utilized jointly by particular units 211, 212, 213, 214, 215 as necessary, the particular software required therefor being encompassed by device 210, for example, as an app.

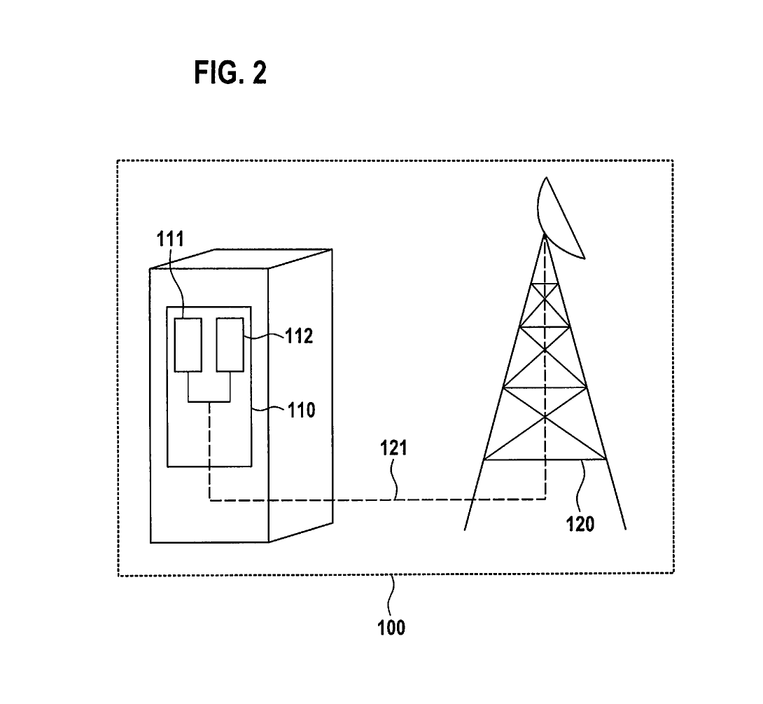

FIG. 2 shows, by way of example, a server 100 for receiving movement data values and providing a warning about a case of wrong-way driving including a transmitting and/or receiving unit 111 for receiving movement data values from a vehicle 200, the movement data values representing at least one measure for a change in movement of vehicle 200, and for providing a warning when vehicle 200 is traveling in the wrong direction. Server 100 further includes a processing unit 112 for determining, depending on the movement data values, whether vehicle 200 is traveling in the wrong direction.

In an example embodiment, server 100 is understood to be a cloud, i.e., a composite of at least two electrical data processing systems that exchange data, for example, via the Internet. In a further example embodiment, server 100 corresponds to a computing device 110, without externally situated transmitting and/or receiving unit 122, which is shown here by way of example, and is connected to computing device 110 with the aid of a wired and/or wireless link 121.

Transmitting and/or receiving unit 111 and/or processing unit 112 can also be designed in different example embodiments depending on the particular example embodiment of server 100. If server 100 is designed as a server in the actual sense, transmitting and/or receiving unit 111 and/or processing unit 112 are/is located at the same position with respect to the position of server 100. If server 100 is designed as a cloud, transmitting and/or receiving unit 111 and/or processing unit 112 can be located at different locations, for example, in different cities and/or in different countries, a link, such as the Internet, for exchanging (electronic) data being formed between transmitting and/or receiving unit 111 and/or processing unit 112.

Transmitting and/or receiving unit 111 is designed for transmitting and/or receiving data or data values. In an example embodiment, transmitting and/or receiving unit 111 is designed in such a way that transmitting and/or receiving unit 111 is connected, proceeding from computing device 110, to an externally situated transmitting and/or receiving unit 122 with the aid of a wired and/or wireless link 121. In this case, transmitting and/or receiving unit 111 is utilized as an interface between externally situated transmitting and/or receiving unit 122 and computing device 110. Moreover, transmitting and/or receiving unit 111 includes, for example, electronic data processing elements, for example, a processor, a working memory, and a hard drive, which are designed for storing and/or processing the movement data values, for example, carrying out a change and/or an adaptation of the data format and, thereafter, forwarding the movement data values to processing unit 112, and/or, when vehicle 200 is traveling in the wrong direction, providing the warning, for example, as data values in such a way that the warning can be transmitted and received in the form of data values.

Processing unit 112 for determining, depending on the movement data values, whether vehicle 200 is traveling in the wrong direction, includes, for example, a processor, a working memory, a hard drive, and appropriately designed software. In this case, processing unit 112 is designed, for example, for requesting further information in the form of data values, for example, with the aid of transmitting and/or receiving unit 111.

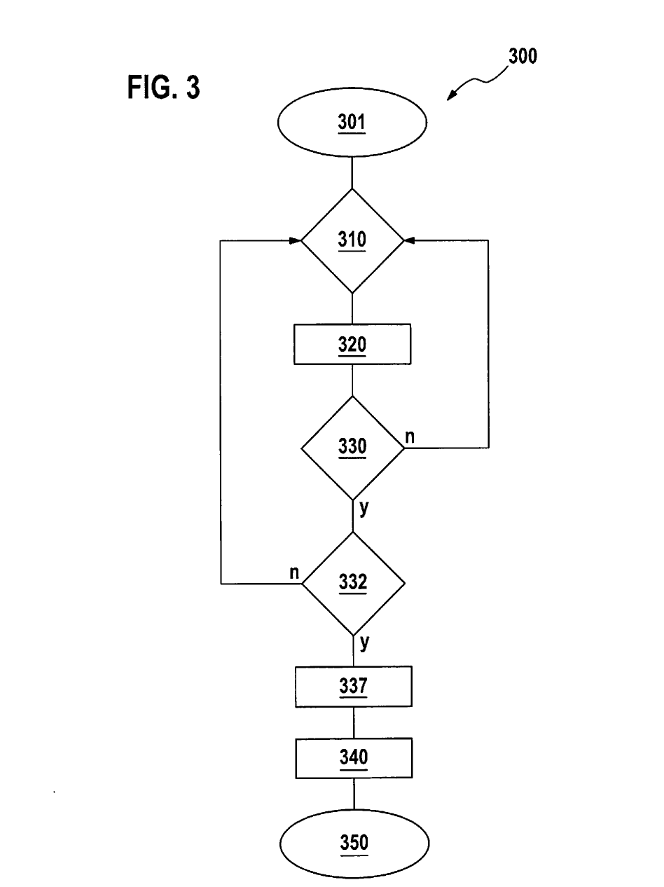

FIG. 3 shows an exemplary embodiment of a method 300 for determining whether a vehicle 200 is traveling in the wrong direction. The method starts in step 301. This takes place, for example, automatically, by way of vehicle 200 setting out on a trip and device 210 in vehicle 200 being appropriately designed. In an example embodiment, method 300 starts, for example, by way of an appropriate program, in particular when device 210 is designed as a smartphone, being started, for example, by a driver of vehicle 200 when setting out on a trip.

A traffic route on which vehicle 200 is located is determined in step 310.

In step 320, movement data values are gathered, the movement data values representing at least one measure for a change in movement of vehicle 200.

In step 330, the movement data values are transmitted to a server 100 when the measure for a predefinable or predefined behavior deviates according to predefined criteria, the behavior being predefinable or predefined depending on the traffic route. Whether the measure for the change in movement deviates from a predefinable or predefined behavior is determined with the aid of evaluation unit 213. If the measure does not deviate, step 310 follows. If the measure deviates and the movement data values are transmitted to server 100, step 332 follows.

In step 332, the movement data values are received by server 100, server 100 being designed for determining, depending on the movement data values, whether vehicle 200 is traveling in the wrong direction and providing a warning about this wrong-way driving when vehicle 200 is traveling in the wrong direction.

For example, it is determined whether vehicle 200 is traveling in the wrong direction by way of the change in movement being compared to further changes in movement of further vehicles, which have already been received by server 100. In this case, for example, it is determined that the vehicle is not driving in the wrong direction when multiple vehicles undergo a change in movement, at the same point, which deviates from a predefinable or predefined behavior, but which can be due to a construction site, an accident, etc. In a further example embodiment, the change in movement or the location at which the change in movement is carried out by vehicle 200 is compared, for example, to up-to-date traffic jam information. These traffic jam data are provided, for example, by a (public) center set up for this purpose. In a further example embodiment, it is determined, for example, whether vehicle 200 is traveling in the wrong direction by way of the change in movement per se being validated. For example, a check is carried out to determine whether the change in movement can even be caused by a driver at all or, instead, whether the change in movement is due to an accident (for example, a rotation of vehicle 200 due to a collision). This takes place, for example, by way of processing unit 112 of server 100 carrying out a comparison of the change in movement with stored profiles of changes in movement. The list of possibilities for the way in which server 100 determines whether vehicle 200 is traveling in the wrong direction is merely a list of examples and is not conclusive.

If vehicle 200 is not traveling in the wrong direction, step 310 follows. If vehicle 200 is traveling in the wrong direction, step 337 takes place. In step 337, a warning about wrong-way driving is provided in such a way that at least vehicle 200 can receive this warning. In step 340, the warning about vehicle 200 traveling in the wrong direction is received by vehicle 200 and/or by further road users.

Method 300 ends in step 350.

What is claimed is:

1. A device comprising:
a sensor;
a processor; and
a communication interface;
wherein:
the sensor is configured to provide movement data values that represent a measure of a change in movement of a vehicle; and
the processor is configured to:
obtain a traffic route on which the vehicle is located;
determine whether the measure of the change in movement deviates from behavior that is expected based on the traffic route; and
transmit the movement data values, to a server and via the communication interface, when a result of the determination is that the measure deviates from the expected behavior according to predefined criteria.

2. The device of claim 1, wherein the processor is configured to receive, from the server and via the communication interface, a warning about the vehicle traveling in a wrong direction.

3. The device of claim 2, further comprising an output via which the device is configured to output the warning any one or more of the following three manners: visually, acoustically, and haptically.

4. The device of claim 1, wherein the device is a mobile device.

5. The device of claim 1, wherein the device is a smartphone.

6. A server comprising:
a processor; and
a communication interface;
wherein the processor is configured to:
receive, from a vehicle and via the communication interface, movement data values that include a representation of a measure of a change in movement of the vehicle;
determine, based on the measure of the change, that the vehicle is traveling in a wrong direction; and
in response to the determination, transmit a warning to the vehicle via the communication interface.

7. The server of claim 6, wherein the movement data values additionally include a representation of a traffic route on which the vehicle is located, and the determination that the vehicle is traveling in the wrong direction is additionally based on the traffic route.

8. The server of claim 6, wherein the transmission of the warning is to the vehicle.

9. The server of claim 6, wherein the transmission of the warning is to another vehicle.

10. The server of claim 6, wherein the transmission of the warning is to the vehicle and to another vehicle.

11. A method comprising:
determining a traffic route on which a vehicle is located;
obtaining movement data values that represent a measure of a change in movement of the vehicle;
transmit the movement data values to a server when the measure deviates, according to predefined criteria, from behavior that is expected based on the traffic route, wherein the server is configured to determine, based on the movement data values, that the vehicle is traveling in a wrong direction; and
receiving from the server a warning about the vehicle traveling in the wrong direction.
